(19) United States
(12) Patent Application Publication
(10) Pub. No.: US 2007/0120641 A1
(43) Pub. Date: May 31, 2007

(54) Programming device for transmitter/receiver systems for contactlessly actuating doors and gates

(75) Inventors: Frank-Uwe Sommer, Kirchheim/Teck (DE); Frank Sommer, Kirchheim/Teck (DE)

Correspondence Address: VENABLE LLP, P.O. BOX 34385, WASHINGTON, DC, 20043-9998, US

(73) Assignee: Sommer Antriebs- und Funktechnik GmbH, Kircheim/Teck (DE)

(21) Appl. No.: 10/587,038

(22) PCT Filed: Jan. 13, 2005
(86) PCT No.: PCT/EP05/00253

§ 371 Date: Jul. 24, 2006

(30) Foreign Application Priority Data
Jan. 22, 2004 (DE) 10 2004 003 212.2

(51) Int. Cl. H04L 9/32

(52) U.S. Cl. 340/5.22; 340/5.64; 340/5.71

(57) ABSTRACT

The invention relates to a programming apparatus for programming transmitter/receiver systems for contactless actuation of doors and gates. For actuation of a door or a gate by a transmitter of a transmitter/receiver system a transmitter code is read into an associated receiver and compared there with receiver codes. The programming apparatus according to the invention comprises a computer unit for management of the transmitter codes and the receiver codes of the transmitter/receiver systems. In addition, the programming apparatus according to the invention includes an input unit for definition of the transmitter codes and the receiver codes of the transmitter/receiver systems. Moreover, the programming apparatus according to the invention comprises an interface unit for connection of transmitters and receivers, by way of which receiver codes can be issued at connected receivers and transmitter codes at connected transmitters. In the computer unit there are defined, for each transmitter/receiver system, transmitter codes for the transmitter thereof as subsets of the receiver codes of the receiver thereof.

The invention relates to a programming apparatus for transmitter/receiver systems for contactless actuation of doors and gates.

Transmitter/receiver systems of that kind form multi-component systems for remote control or remote coding of doors and gates. A multi-component system of that kind serves, for example, for radio-controlled opening and closing of one or more garage doors. A hand-held radio transmitter as transmitter, by which a transmitter code can be transmitted to a radio receiver, which is associated with the door drive of a garage door, as receiver in order to open or close the garage door by remote control, is present for each authorised person. The opening or closing of the garage door is in that case released by way of an actuating device when the transmitted transmitter code corresponds with a receiver code stored in the radio receiver.

For input of the transmitter codes into the transmitters or the receiver code into the receiver mechanically actuable coding switches can be provided at these units. A coding switch of that kind comprises a switch strip with a predetermined number of switches, wherein each switch has two switching states. Through actuation of the switches there can be input into the transmitter and receiver a binary code as code word, the length of which is predetermined by the number of switches.

A device for allocation of codes of that kind in code-controlled multi-component systems is known from WO 99/76 759, in which the manual code switches are replaced by programmable coding circuits.

This coding circuit has, instead of a switch strip with switches, a number, which corresponds with a number of switches, of manually actuable actuating devices which are a component of a programming device for input of code words. The thus-constructed coding circuit therefore comprises a control surface corresponding with the coding switches so that these units are compatible and in a given case can be exchanged with one another. However, through coupling of the actuating devices to the programming device a code word of any length can be input, wherein the length of the code word is dependent on, in particular, the number of the actuating device.

The invention has the object of providing a programming apparatus for transmitter/receiver systems for contactless actuation of doors and gates which has a high level of operating convenience and in addition ensures reliable and simple allocation of codes for the transmitter/receiver systems.

The features of claim 1 are provided for fulfilment of this object. Advantageous forms of embodiment and expedient developments of the invention are described in the subclaims.

The programming apparatus according to the invention serves for programming transmitter/receiver systems for contactless actuation of doors and gates. For actuation of a door or a gate a transmitter code is read from a transmitter of a transmitter/receiver system into an associated receiver and compared there with receiver codes. The programming apparatus according to the invention comprises a computer unit for management of the transmitter codes and the receiver codes of the transmitter/receiver systems. In addition, the programming apparatus according to the invention includes an input unit for definition of the transmitter codes and receiver codes of the transmitter/receiver systems. Moreover, the programming apparatus according to the invention comprises an interface unit for connection of transmitters and receivers, by way of which receiver codes can be output at connected receivers and transmitter codes at connected transmitters. Defined in the computer unit for each transmitter/receiver system are transmitter codes for the transmitter thereof as subsets of the receiver codes of the receiver thereof.

The basic concept of the invention thus consists in predetermining the transmitter codes and receiver codes of transmitter/receiver systems, which are for contactless actuation of doors and gates, centrally by way of the clamping apparatus. The transmitter/receiver systems can generally transmit infrared signals, ultrasound signals, radio signals or optical signals for remote control or remote operation of doors or gates. In that case, a transmitter/receiver system preferably comprises a receiver associated with an actuating device for actuation of a door or gate. Moreover, the transmitter/receiver system preferably comprises several transmitters in the form of hand-held devices. With particular advantage, the codes of several transmitter/receiver systems can be predetermined by the programming apparatus according to the invention. In that case the transmitter/receiver systems can be used for, in particular, opening and closing garage doors.

In this connection a significant advantage consists in the fact that coding strips or coding circuits of the transmitters and receivers for input of code words are no longer needed. Apart from the fact that this leads to a considerable constructional simplification of the transmitters and receivers, the input of codes for the transmitter/receiver systems is substantially simplified for the user by the central input possibility via the programming apparatus.

In that case a further significant advantage of the invention consists in that the management of the transmitter codes and receiver codes of the transmitter/receiver systems takes place centrally in the programming apparatus, which can be inspected and checked by the user at any time.

If several transmitter/receiver systems are managed in the programming apparatus these are advantageously each provided with an identification on the basis of which they can be uniquely identified. The identification can in that case be predetermined in user-specific manner. The transmitter codes and receiver codes of the respective transmitter/receiver system can be called up and displayed under the identification in the programming apparatus. Moreover, editing for allocation of the transmitter codes and receiver codes can be carried out by way of the input unit.

The receiver codes for the receiver are then initially predetermined for a transmitter/receiver system. This can be carried out by direct input of the receiver codes by way of the input unit. With particular advantage there is stored in the computer unit a list of codes from which the receiver codes can be selected. Multiple selection of a code can be avoided by masking once-predetermined codes by way of the computer unit. This input possibility can be carried out in particularly simple manner.

The receiver codes defined in this way are read into the connected receiver by way of the interface unit.

The allocation of the transmitter codes for this transmitter/receiver system takes place subsequently in that a subset is selected from the receiver codes in the programming apparatus for each transmitter and is read into this by way of the interface unit. Preferably, an individual transmitter code is assigned to each transmitter in that one of the receiver codes is selected by the user and then is read as transmitter code into the transmitter by the programming apparatus. For avoidance of multiple occupations the selected receiver code is masked in the programming apparatus so this cannot be used a second time for definition of a transmitter code. Masking of the receiver codes is advantageously displayed to the user.

Moreover, a change, particularly erasure, of transmitter codes and/or receiver codes of the transmitter/receiver systems can also be undertaken by the programming apparatus. The thus-executed changes are performable in simple manner for the user and in addition readily checkable by way of the updated lists with the corresponding codes in the programming apparatus.

The interface unit for connection of transmitters and receivers can be constructed in the form of an interface adapter. In this case a cable connection is produced between the programming apparatus and the transmitter or receiver to be programmed. The thus-constructed interface unit consists of standard components which can be produced economically. Alternatively, the interface unit can also comprise interfaces for contactless data transmission between the programming apparatus and the transmitters and receivers of the transmitter/receiver systems. This interface unit is particularly suitable for programming receivers at the installation locations thereof in the doors or gates.

In an advantageous form of embodiment of the invention the programming apparatus is connectible with a personal computer or integrated in a personal computer. In this case the terminal of the personal computer can be used as display unit and the keyboard of the personal computer as input unit of the programming apparatus. Moreover, standard programs, particularly text processing programs and table calculation programs, installed in the personal computer can be utilised as software modules for the programming apparatus.

The invention is explained in the following by way of the drawings, in which:

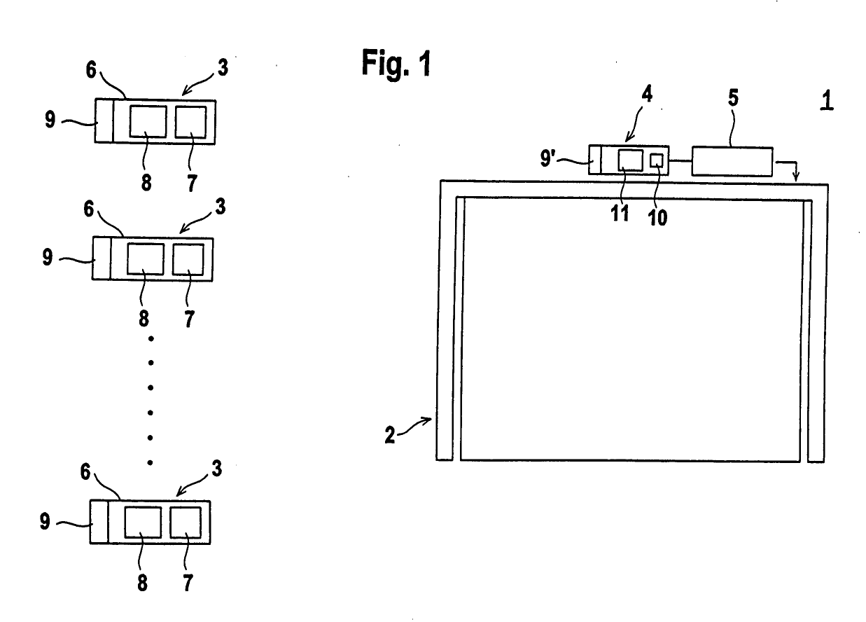

FIG. 1 shows a schematic illustration of a closing system with a transmitter/receiver system for contactless actuation of a garage door,

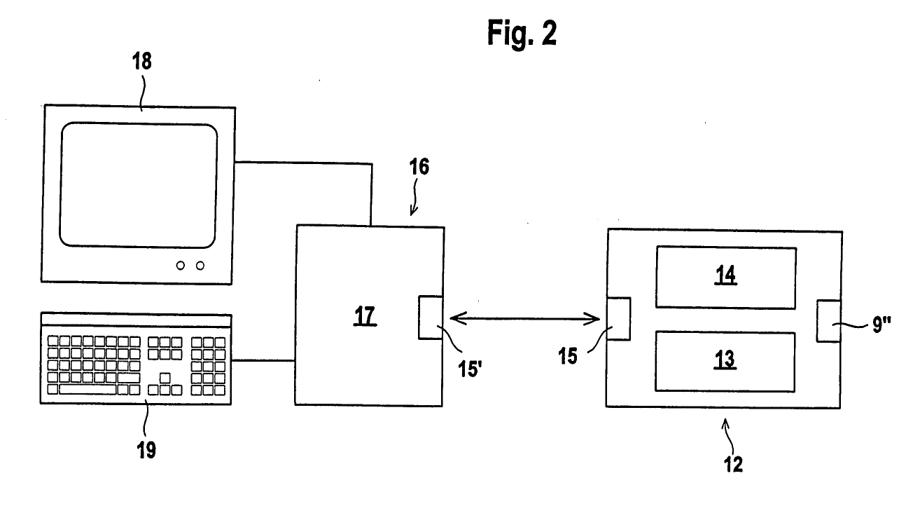

FIG. 2 shows a schematic illustration of a programming apparatus for programming of transmitter/receiver systems according to FIG. 1,

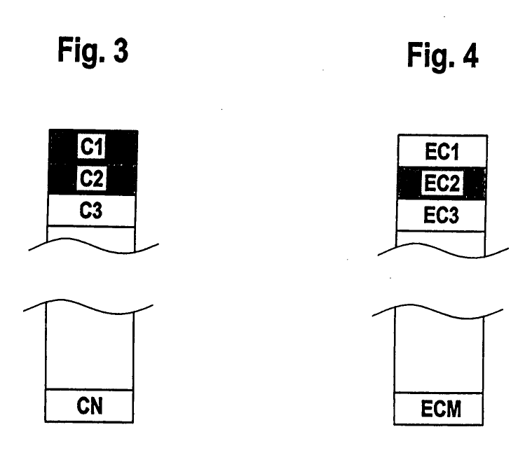

FIG. 3 shows a list of codes, which are stored in the programming apparatus, for definition of receiver codes for transmitter/receiver systems and

FIG. 4 shows a list of receiver codes of a transmitter/receiver system.

FIG. 1 schematically depicts a closing system 1 for contactless actuation of a garage door 2. Instead of a garage door 2 a gate or a door can in general be actuated by the closing system 1.

The closing system 1 comprises a transmitter/receiver system with several transmitters 3 and a receiver 4 associated with the transmitters 3. The receiver 4 is mounted in the region of the garage door 2 and connected with a door drive 5 by which the garage door 2 can be closed and opened.

The transmitters 3 respectively have identical construction. Each transmitter 3 is in that case constructed as a hand-held transmitter integrated in a housing 6. The transmitter 3 comprises a radio transmission module 7 for transmission of coded radio signals. The transmitter 3 is actuable by means of buttons (not illustrated), wherein predetermined radio signals are emitted by actuation of specific button combinations. Moreover, a processor 8 with integrated memory unit and an interface unit 9 are integrated in the transmitter 3. The processor 8 takes over control of the individual components of the transmitter 3.

The receiver 4 comprises a radio receiving module 10 for reception of the radio signals of the transmitter 3, as well as a processor 11 with integrated memory unit, in which the radio signals of the transmitter 3 are decoded, and an interface unit 9′, which is identical with the interface unit 9 of the transmitter 3.

For actuation of the garage door 2 a transmitter 3 is actuated so that this communicates, by the emitted radio signals, a transmitter code to the receiver 4. The decoded transmitter code is compared in the processor 11 of the receiver 4 with receiver codes stored in the memory unit of the processor 11 in the receiver 4. If the read-in transmitter code corresponds with one of the stored receiver codes the door drive 5 for opening and closing the garage door 2 is actuated.

Individual transmitter codes are stored in the transmitters 3 of the transmitter/receiver system, wherein these are filed in the receiver 4 as receiver codes. Thus, only these transmitters 3 form authorised transmitting units by means of which the garage door 2 can be opened and closed.

In general, transmitter/receiver systems of that kind can transmit and receive, instead of radio signals, also optical signals, especially infrared signals, ultrasound signals or the like. In every case transmission of the signals takes place in the form of transmitter codes which are compared, at the receiver, with receiver codes for release of the actuation of a door or a gate.

In the case of complex installations in buildings typically also several closing systems 1 can be used. In particular, several closing systems 1 with transmitter/receiver systems according to FIG. 1 can be used for opening and closing a number of garage doors 2.

The programming apparatus 12 according to FIG. 2 is provided for configuring transmitter/receiver systems of that kind, particularly for allocation of the transmitter codes and receiver codes for the individual transmitter/receiver systems.

The programming apparatus 12 comprises an interface unit 9″ for connection of the transmitters 3 and receivers 4 of transmitter/receiver systems according to FIG. 1. In that case the interface unit 9″ of the programming apparatus 12 is constructed identically to the interface units 9, 9′ of the transmitters 3 and receivers 4. In the present case the interface units 9, 9′, 9″ are constructed as interface adapters each with a respective serial interface. The connection between the programming apparatus 12 and a transmitter 3 or receiver 4 is produced by way of a connecting cable (not illustrated). The portable transmitters 3 are for this purpose brought to the programming apparatus 12. The receiver 4 is also brought for this purpose to the programming apparatus 12, wherein the receiver 4 is connectible with the programming apparatus before being placed in operation. In addition, the receiver 4 can also be detached from its respective installation position at the garage door 2 and connected with the programming apparatus 12. In that case the receiver 4 does not need to have an own voltage supply. Finally, the receiver 4 can in principle also be connected, at its respective installation position at the garage door 2, with the programming apparatus 12.

In principle, the interface units 9, 9′, 9″ can also be formed by interfaces for contactless data transmission between the programming apparatus 12 on the one hand and the transmitters 3 and the receivers 4 of the transmitter/receiver systems on the other hand. The data transmission can be carried out by exchange of optical signals, particularly infrared signals, radio signals or ultrasound signals.

The programming apparatus 12 comprises a computer unit 13 for controlling the functions and components of the programming apparatus 12. Moreover, the programming apparatus 12 has a control field 14 which serves as display unit for display of data and as input unit for input of data.

Finally, the programming apparatus 12 comprises an interface 15 by way of which the programming apparatus 12 is connectible with a corresponding interface 15′ of a personal computer 16. The personal computer 16 comprises a processor unit 17 as well as a terminal 18 and a keyboard 19. The terminal 18 can be used as display unit for the connected programming apparatus 12. The keyboard 19 of the personal computer 16 can be used as input unit for the programming apparatus 12.

In general, the programming apparatus 12 can also be constructed as an autonomous unit which can be operated without a personal computer 16 or the like. Moreover, the programming apparatus 12 can also be integrated in a personal computer 16 or the like.

The programming apparatus 12 serves for programming transmitter/receiver systems, particularly for programming transmitter codes into the transmitters 3 and receiver codes into the receivers 4 of preferably several transmitter/receiver systems.

For a transmitter/receiver system, prior to placing this in operation the receiver 4 is initially connected with the programming apparatus 12 by way of the interface unit 9′. A predetermined number of receiver codes is then input for the receiver 4 by way of the input unit. These receiver codes are preferably stored in the computer unit 13 of the programming apparatus 12 under an identification characterising the transmitter/receiver system to which the receiver 4 belongs. The identification can preferably be freely selected by the user. The programming can be carried out by direct input of the receiver codes by way of the input unit. In a particularly advantageous form of embodiment the programming can take place in menu-guided manner, wherein a number of codes, from which the user can select the receiver codes, stored in the computer unit 13 of the programming apparatus 12 are displayed to the user.

A table of that kind with codes C1, C2, . . . CN is schematically illustrated in FIG. 3. The user can select from these codes a predetermined number as receiver codes. In order to avoid multiple allocation of a code as receiver code a code predetermined once as a receiver code is masked by way of the computer unit 13 of the programming apparatus 12 so that this is blocked for further allocation as a receiver code. In the case of the example of embodiment the first two codes are masked, which is displayed to the user by way of an appropriate graphical marking. The remaining codes C3, . . . CN are still available for allocation as receiver codes. Depending on the respective construction of the software in the computer unit 13 the codes C1, C2, . . . are allocated as receiver codes in correspondence with their sequence in the table or can be freely selected by the user.

In the case of the preferred menu-guided programming of the receiver 4 preferably also further data can be input into the programming apparatus 12. The constructional type of the receiver 4 as well as the serial number thereof, for example, belong to these data. Moreover, a receiver 4 can have several channels for reception of radio signals. In that case the channel of the receiver 4 to which the receiver codes to be read in are respectively allocated can also be input. The number of the associated transmitter 3 and thus the total number of the receiver codes to be input can preferably also be interrogated prior to commencement of programming of the receiver 4.

After the receiver codes have been input into the programming apparatus 12 these are read by the programming apparatus 12 into the connected receivers 4. The reading-in process carried out is displayed to the user preferably by way of the display unit of the programming apparatus 12.

In the present case, M receiver codes EC1, . . . ECM, which are illustrated in the table in FIG. 4, were learnt for a receiver 4 of a transmitter/receiver system.

The transmitter codes for the transmitters 3 of this transmitter/receiver system are subsequently allocated by way of these learnt receiver codes.

For programming of a transmitter 3 this is connected by way of the interface unit 9″ with the programming apparatus 12. The user then selects from the table of the receiver codes, which table is displayed at the display unit, a receiver code which is assigned to the transmitter 3 as transmitter code. This assignment is stored together with further data of the transmitter 3, particularly the constructional type and the serial number of the transmitter 3, in the computer unit 13 of the programming apparatus 12 under the identification of the relevant transmitter/receiver system. The transmitter code is thereafter read by the programming unit 12 into the transmitter 3, wherein the reading-in process is again displayed by way of the display unit and acknowledged.

So that different transmitters 3 are allocated individual, unique transmitter codes, there takes place after allocation of a transmitter code from the table according to FIG. 4 as transmitter code a masking of this receiver code. This receiver code is thus blocked for further allocation as a transmitter code. The masking of the predetermined receiver code is again graphically displayed. In the present example of embodiment the receiver code EC2 in FIG. 4 is marked, whereas the remaining receiver codes are still available for allocation as transmitter codes.

After allocation of the transmitter codes for the transmitters 3 and the receivers 4 of a transmitter/receiver system the corresponding closing system 1 is operationally ready.

In addition, after placing in operation, the transmitter codes and receiver codes for a transmitter/receiver system can be changed by means of the programming apparatus 12. In particular, transmitter codes and receiver codes can also be erased. The corresponding programming of changes takes place by way of the programming apparatus 12 in correspondence with the first allocation of transmitter codes and receiver codes.

The current versions of the transmitter codes and receiver codes allocated for the transmitter/receiver systems are managed in the programming apparatus 12. In particular, the history of different versions of sets with transmitter codes and receiver codes for a transmitter/receiver system can be stored there. Preferably, for this purpose also the points in time of creation of the individual versions are established. These versions can be displayed by way of the display unit. If management of the transmitter codes and receiver codes is not possible solely by the programming apparatus, the connected personal computer 16 can be additionally used for that purpose.

### Reference Numeral List

(1) closing system
(2) garage door
(3) transmitter
(4) receiver
(5) door drive
(6) housing
(7) radio transmission module
(8) processor
(9, 9′, 9″) interface unit
(10) radio reception module
(11) processor
(12) programming apparatus
(13) computer unit
(14) control field
(15, 15′) interface
(16) personal computer
(17) processor unit
(18) terminal
(19) keyboard
C1 code
CN code
EC1 receiver code
ECM receiver code

1. Programming apparatus for transmitter/receiver systems for contactless actuation of doors and gates, wherein for actuation of a door or gate by a transmitter of a transmitter/receiver system a transmitter code is read into an associated receiver and compared there with receiver codes, comprising the following components:
a computer unit for management of the transmitter codes and the receiver codes of the transmitter/receiver systems,
an input unit for definition of the transmitter codes and the receiver codes of the transmitter/receiver systems and
an interface unit for connection of transmitters and receivers, by way of which receiver codes can be issued at connected receivers and transmitter codes at connected transmitters, wherein defined in the computer unit for each transmitter/receiver system are transmitter codes for the transmitter thereof as subsets of the receiver codes of the receiver thereof.

2. Programming apparatus according to claim 1, characterised in that this comprises a display unit by means of which the transmitter codes and receiver codes can be visualised.

3. Programming apparatus according to claim 1, characterised in that a specific identification is allocated in the apparatus to the transmitter codes and receiver codes of a transmitter/receiver system.

4. Programming apparatus according to claim 3, characterised in that the transmitter codes and receiver codes of a transmitter/receiver system are stored in the computer unit under the identification.

5. Programming apparatus according to claim 3, characterised in that the identification is predeterminable by way of the input unit.

6. Programming apparatus according to claim 1, characterised in that a list of codes from which receiver codes are selectable by means of the input unit is stored in the computer unit.

7. Programming apparatus according to claim 1, characterised in that the receiver codes can be input by means of the input unit.

8. Programming apparatus according to claim 6, characterised in that a transmitter code for a transmitter of a transmitter/receiver system is predeterminable by selection from the receiver codes of the associated receiver by means of the input unit.

9. Programming apparatus according to claim 8, characterised in that a receiver code allocated as transmitter code is masked in the computer unit, wherein masked receiver codes are blocked for a further allocation of the transmitter codes.

10. Programming apparatus according to claim 1, characterised in that receiver codes for a receiver and/or transmitter codes for a transmitter of a transmitter/receiver system are variable by means of the input unit.

11. Programming apparatus according to claim 10, characterised in that receiver codes and/or transmitter codes are erasable by means of the input unit.

12. Programming apparatus according to claim 1, characterised in that the respective current version of the transmitter codes and receiver codes is stored in the computer unit.

13. Programming apparatus according to claim 12, characterised in that updated transmitters codes can be output at the respective transmitter and/or updated receiver codes at the respective receiver by way of the interface unit.

14. Programming apparatus according to claim 1, characterised in that the apparatus is connectible with a personal computer.

15. Programming apparatus according to claim 1, characterised in that the apparatus is integrated in a personal computer.

16. Programming apparatus according to claim 14, characterised in that the display unit is formed by a terminal.

17. Programming apparatus according to claim 14, characterised in that the input unit is formed by a keyboard.

18. Programming apparatus according to claim 1, characterised in that the interface unit comprises at least one interface adapter.

19. Programming apparatus according to claim 1, characterised in that the interface unit comprises at least one interface for contactless data transmission.
